(19) United States
(12) Patent Application Publication
(10) Pub. No.: US 2015/0165877 A1
(43) Pub. Date: Jun. 18, 2015

(54) SUN VISOR FOR VEHICLE

(71) Applicant: Hyundai Motor Company, Seoul (KR)

(72) Inventors: Seung Kwon CHA, Yongin-si (KR); Dae lk JUNG, Suwon-si (KR)

(73) Assignee: Hyundai Motor Company, Seoul (KR)

(21) Appl. No.: 14/303,380

(22) Filed: Jun. 12, 2014

(30) Foreign Application Priority Data
Dec. 18, 2013 (KR) 10-2013-0158754

(51) Int. Cl. B60J 3/02

(52) U.S. Cl. CPC B60J 3/026; B60J 3/0282

(57) ABSTRACT

A sun visor for a vehicle may include a plate-like body portion having a predetermined thickness, and a pivot arm having one end secured to a support bar and the other end joined to a connection member at a cut section where an elastic member is provided. The elastic member contacts with a surface of an outer circumference of the pivot arm when the body portion is rotated. The sun visor may also include a clamp which is connected sideways to the body portion and securely collars an outer side of the pivot arm to the support bar.

### CROSS REFERENCE TO RELATED APPLICATION

The present application claims priority of Korean Patent Application Number 10-2013-0158754 filed on Dec. 18, 2013, the entire contents of which application are incorporated herein for all purposes by this reference.

### BACKGROUND OF INVENTION

1. Field of Invention

The present invention relates to a sun visor for a vehicle in which a support structure for a clamp, which is installed to a sun visor for a vehicle and coupled to a pivot arm that is hinged to the vehicle headliner, is improved thereby to minimize a deflection of the sun visor and a floating of the clamp.

2. Description of Related Art

Generally, the interior of a vehicle contains different kinds of various convenience devices or equipment, which are positioned in locations comfortable for use by a passenger. Among these, a sun visor is provided as a sunlight cover for front-seat passengers by partially blocking the sun's rays from entering the interior space of a vehicle through windshield or side door glass (hereinafter referred to as “side window”).

This type of sun visor is usually stored in a folded position within close contact to the interior headliner and unfolded from the headliner to be rotated in the direction of radiant sunshine to block the light when sunlight enters the interior of the vehicle.

Korean Utility Model Publication No. 20-2010-0003528 U discloses a sun visor for a vehicle including: a clamp through which a pivot arm installed pivotally in a vehicle interior is arranged to pass; and a bracket to which the clamp is fixed wherein the clamp includes a cover to wrap and support the pivot arm and a plate spring, inserted in the cover, a lower end of which is fixed and an upper end of which supports elastically the pivot arm, wherein the plate spring includes: a support portion that supports the pivot arm while it is moved up/downwardly inside the cover; a first elastic portion that is bent downwardly on both sides of the support portion; a second elastic portion that is bent downwardly at the end of the first elastic portion; and a third elastic portion which is bent upwardly at the end of the second elastic portion and the ends of which are formed as free ends.

However, regarding the above vehicle sun visor, the clamp wrapped around the support shaft of the sun visor and the rotating shaft for rotating the sun visor are formed in the inside of the sun visor and thus a thickness of the sun visor is increased, which results in a reduction of headroom space

Therefore, it is necessary develop a sun visor for a vehicle with a reduced thickness capable of satisfying aesthetic trends in coupe design while still additionally securing the interior space of the vehicle.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention is directed to solve the aforementioned problems associated with the prior art and/or other problems and to provide a sun visor with a reduced thickness capable of satisfying aesthetic trends in coupe design while still additionally securing the interior space of the vehicle.

A sun visor for a vehicle according to the present invention may include a plate-like body portion having a predetermined thickness, a pivot arm having one end secured to a support bar and the other end joined to a connection member at a cut section where an elastic member is provided, wherein the elastic member contacts with a surface of an outer circumference of the pivot arm when the body portion is rotated, and a clamp which is connected sideways to the body portion and securely collars an outer side of the pivot arm to the support bar.

A rigid rod formed of a rigid material may be inserted into the pivot arm in a length direction of the pivot arm. The elastic member may be a plate spring, which maintains a rotated state of the body portion by pressing downward the pivot arm as the elastic member contacts the cut section of the pivot arm by the rotation of the body portion.

The pivot arm may be secured to one end of the support bar and a wing unit extending downwardly is formed on the other end of the support bar such that the body portion is supported by the wing unit when the body portion rotates around the pivot arm. The wing units may be formed on both sides of the body portion, respectively.

A through hole may be formed through a side surface of the clamp and a protrusion may be formed on the pivot arm wherein the protrusion is fitted into the through hole. The clamp may be formed by a combination of a plurality of separate parts that are to be coupled.

The support bar may be a rectangular pillar, wherein the length thereof is adjustable. One end of the connection member may be coupled to a vehicle body and the other end thereof may be coupled to the pivot arm. The connection member may be shaped as “L” character.

An opening surface may be formed toward a vehicle's interior on the body portion and an extended portion may be provided on the body portion and formed by an outermost of the body portion extended toward the opening surface at a predetermined length along a border of the opening surface.

A mirror may be inserted into an inward side of the opening surface wherein the mirror is prevented from becoming detached from the body portion by the extended portion. A door for opening or closing the mirror may be provided on the opening surface to be guided by the extended portion when the door is slid. A ticket holder may be formed on one side of the body portion.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to exemplary embodiments thereof illustrating the accompanying drawing which are given herein below by way of illustration only, and thus are not limitative of the present invention, and wherein:

FIG. 1 is a view of an exemplary sun visor for a vehicle according to the present invention;

FIG. 2 is an exploded perspective view of a support bar, clamp, pivot arm, and connection member of the sun visor shown in FIG. 1;

FIG. 3 is a detailed sectional view of a pivot arm taken along line A-A of FIG. 1;

FIG. 4 is a detailed view of part of a wing unit shown in FIG. 1;

FIG. 5 is a sectional view of the sun visor body taken along line B-B of FIG. 1; and

FIG. 6 is a sectional view taken along line C-C of FIG. 1.

It should be understood that the accompanying drawings are not necessarily to scale, presenting a somewhat simplified representation of various exemplary features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, a sun visor for a vehicle is described with reference to the accompanying drawings according to various embodiments of the invention.

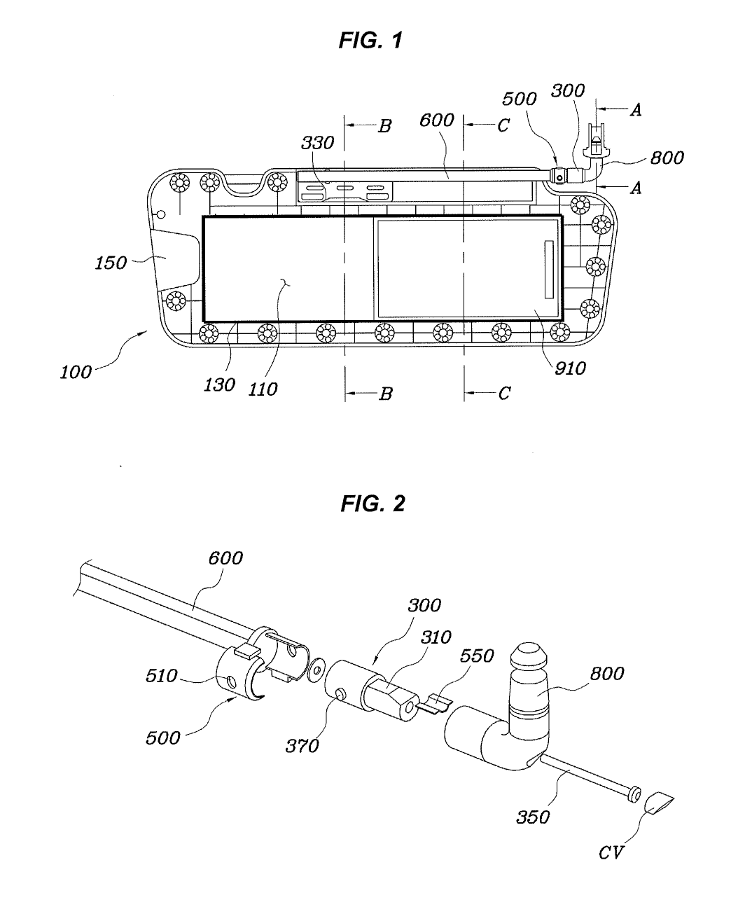

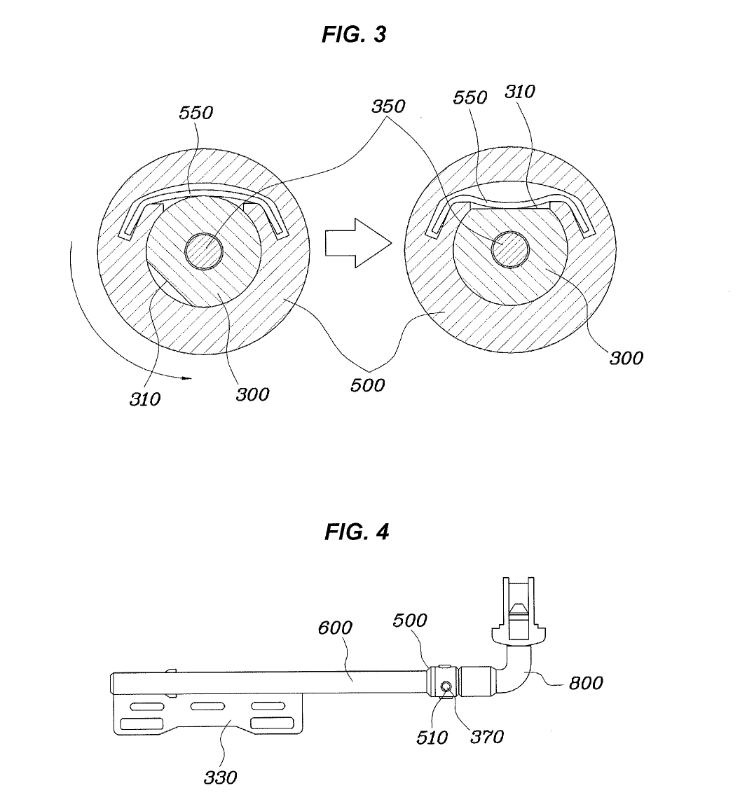

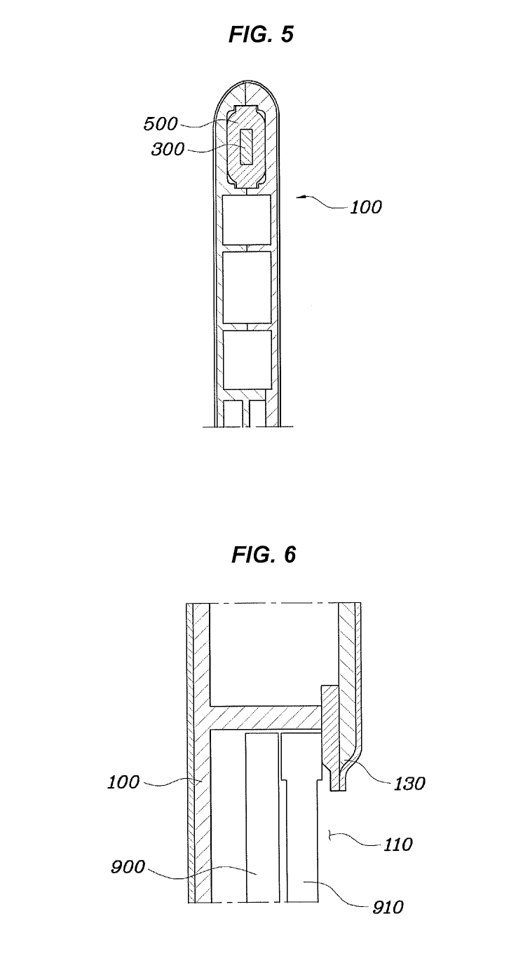

FIG. 1 is a view of a sun visor for a vehicle according to various embodiments of the present invention. FIG. 2 is an exploded perspective view of a support bar 600, a clamp 500, a pivot arm 300, and a connection member 800 according to various embodiments of the present invention. FIG. 3 is a detailed sectional view of a pivot arm taken along line A-A of FIG. 1. FIG. 4 is a detailed view of part of a wing unit according to various embodiments of the present invention. FIG. 5 is a sectional view of the sun visor body taken along line B-B of FIG. 1. FIG. 6 is a sectional view taken along line C-C of FIG. 1.

A sun visor for a vehicle according to various embodiments of the present invention includes: a plate-like body portion 100 having a predetermined thickness; a pivot arm 300 wherein one end is secured to a support bar 600 and the other end is joined to a connection member 800 at a section which is cut to form a cut section 310 and wherein an elastic member 550 is provided which contacts with the surface of the outer circumference of the pivot arm 300 when the body portion 100 is rotated; and a clamp 500 which is connected sideways to the body portion 100 to securely collar the outer side of the pivot arm 300 to the support bar 600.

The body portion 100 rotates in either the vertical or horizontal direction around the pivot arm 300 as a central axis of rotation and serves to block sunshine or light from entering the interior space of the vehicle. According to a related art the pivot arm is bent to form an “L” shape, whereas the pivot arm 300 of the present invention is formed in a “-” shape. The support bar 600 is formed in a rectangular shape, such as a pillar or bar, and further may be formed retract or extend to variable lengths in a manner similar to an antenna. In addition, according to the present invention the support bar 600, the pivot arm 300, and the connection member 800 are formed separately. However, two or more components of them can also be formed integrally or monolithically.

The pivot arm 300 wherein one end is secured to a support bar 600 and the other end is joined to a connection member 800 at a section which is cut to form a cut section 310 is provided and an elastic member 550 which contacts the surface of the outer circumference of the pivot arm 300 when the above body portion 100 is rotated is provided on the pivot arm.

A rigid rod 350 formed of a rigid material is inserted into the pivot arm 300 in a length direction in order to reinforce the support bar 600 and the pivot arm 300 formed thinner than in previous versions which, during operation of a vehicle or the use of an extension, serves to protect against damage from vibration, impact, or its own weight.

The connection member 800 has one end coupled to the roof panel of the vehicle body and the other end coupled to the pivot arm 300. Since the pivot arm 300 is coupled to the roof panel of the vehicle via an “L”-shaped connection member 800, although the pivot arm 300 is not bent, the body portion 100 can rotate horizontally to the right or the left.

Further, an anchoring member may be provided which fixes the connection member 800 to the vehicle body. The roof panel of the vehicle body and the body portion 100 are spaced apart at least a certain distance by the distance of the extended portion of the connection member 800 and the anchoring member or by a predetermined distance; therefore the body portion 100 is prevented from contacting the vehicle body, and the overlap of the roof panel and body portion 100 is to become minimal, thereby blocking more efficiently sunlight and light, etc., from entering the interior space of the vehicle.

The clamp 500 is coupled to one side of the body portion 100 and forms a wrap around the outside of the pivot arm 300. A through hole 510 is formed on the side of the clamp 500 and a protrusion 370 is formed on the pivot arm 300 which is fitted into the through hole 510. In particular, since the clamp 500 is formed by the combination of a plurality of separately parts, assembly becomes easier when it is manufactured. According to the present invention the protrusion 370 is fitted into through hole 510 thereby to prevent the pivot arm 300 from being vibrated or slid even when the body portion 100 rotates.

The pivot arm 300 is coupled to one end of the support bar 600 and a wing unit 330 that is extended downward and shaped as a key is formed on the other end of the support bar 600 to support the body portion 100 not to be vibrated or deviated from the path when the body portion 100 rotates around the pivot arm 300 or extended. Further, the wing unit 33 prevents the body portion 100 from being vibrated or deviated, which is caused from vibration or shock when the vehicle is running due to tolerance and clearance generated during assembly of the body portion 100 and the pivot arm 300.

The wing unit 330 may be formed on one side or both sides of the body portion 100. FIG. 4 shows an illustration of the wing unit 330 formed in the shape of a “W”, but since such a design or shape may vary depending on the environment, the shape is not limited to what is illustrated.

The clamp 500 is coupled to the outer side of the pivot arm 300 and the elastic member 550 is positioned at the upper inner side of the pivot arm 300. The elastic member 550 is a plate spring, and maintains the rotated state of the body portion 100 by pressing downward the pivot arm 300 as the elastic member 550 contacts with the cut section of the pivot arm 300 by the rotation of body portion 100.

Specially, since the clamp 500 is located on the outer side of the pivot arm 300, upon the rotation of the body portion 100, the friction of the elastic member 550 and the clamp 500 serves to regulate rotational torque.

FIG. 2 shows the coupling of a support bar 600, the pivot arm 300, the connection member 800 and the clamp 500. The cylindrical pivot arm 300 with a stepped portion is coupled to the end of the support bar 600 with a flange. The cut section 310 is formed on the pivot arm 300 and the elastic member 550 is provided on the upper side of the pivot arm 300. The clamp 500 is coupled to the outer side of the pivot arm 300 by wrapping the pivot arm 300. Specifically, the protrusion 370 of the pivot arm 300 is fitted into the through hole 510 of the clamp 500 thereby to prevent the detachment of the body portion 100 due to vibration, impact, etc., during rotation of the body portion 100.

In addition, the connection member 800 is coupled to the other end of the pivot arm 300. Specifically, the rigid rod 350 is coupled to the other end of the pivot arm 300 by passing through the hole formed in the connection member 800, which is enclosed by a cover. The connection member 800 is coupled to the roof panel of the vehicle body, thereby allowing the body portion 100 to rotate in vertical and horizontal directions. In addition, as illustrated in FIG. 1 or FIG. 4, the separate anchoring member may be formed in the roof panel of the vehicle body and the connection member 800 may be coupled to the anchoring member.

Additionally, as shown in FIG. 6, an opening surface 110 is formed toward the vehicle's interior on the body portion 100 and an extended portion 130 wherein the outermost aspects of the body portion 100 is extended toward the opening surface 110 at a predetermined length along the border of the opening surface 110 is provided also on the body portion. The extended portion 130 is shaped to wrap the ends of the body portion 100, thereby supporting more efficiently a mirror 900 and a door 910 and improving the aesthetic appearance.

That is, an accommodating space is formed on the interior of the body portion 100 and the mirror 900 is inserted in the space. The rear of the mirror 900 may be coupled to the body portion 100 via coupling means. However, the coupling means are not used or used as supplemental coupling means in the present invention, and the mirror is supported by the extension portion 130 not to be detached from the body portion 100.

A door 910 for opening or closing the mirror 900 is provided on the opening surface 110 of the body portion 100. When the door 910 is opened or closed, the door 910 is guided by the extension portion 130 to be slid thereby not to be detached from the opening surface 110 of the body portion 100. In addition, since a ticket holder 150 is formed on one side of the body portion 100, the convenience of the user is increased.

According to the sun visor for a vehicle as configured above the shielding effect is increased by efficiently blocking sunshine, light, etc., with removing a portion overlapping with the roof panel by forming the sun visor to be spaced from the roof panel of the vehicle body.

In addition, according to the sun visor for a vehicle of the present invention the clamp is not coupled to the body portion itself but to the outer part of the body portion. As a result, through the reduction of the number of component parts and thickness, interior headroom space is increased and aesthetic trends in coupe design are satisfied. Thus, the increase in interior headroom has the advantage of improving livability and brand image. As a result, the structure is simplified, the assembly process becomes shorter, production efficiency increases, and defective write-offs decrease with the overall effect of cost reduction. As follows, the simplified structure shortens the assembly process thereby increasing productivity and decreasing the occurrence of defective products resulting in cost reduction.

For convenience in explanation and accurate definition in the appended claims, the terms “left” or “right”, or “inner” or “outer”, “front” or “rear”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A sun visor for a vehicle, comprising:
a plate-like body portion having a predetermined thickness;
a pivot arm having one end secured to a support bar and the other end joined to a connection member at a cut section where an elastic member is provided, wherein the elastic member contacts with a surface of an outer circumference of the pivot arm when the body portion is rotated; and
a clamp which is connected sideways to the body portion and securely collars an outer side of the pivot arm to the support bar.

2. The sun visor for a vehicle according to claim 1, wherein a rigid rod formed of a rigid material is inserted into the pivot arm in a length direction of the pivot arm.

3. The sun visor for a vehicle according to claim 1, wherein the elastic member is a plate spring, which maintains a rotated state of the body portion by pressing downward the pivot arm as the elastic member contacts the cut section of the pivot arm by the rotation of the body portion.

4. The sun visor for a vehicle according to claim 1, wherein the pivot arm is secured to one end of the support bar and a wing unit extending downwardly is formed on the other end of the support bar such that the body portion is supported by the wing unit when the body portion rotates around the pivot arm.

5. The sun visor for a vehicle according to claim 4, wherein wing units are formed on both sides of the body portion, respectively.

6. The sun visor for a vehicle according to claim 1, wherein a through hole is formed through a side surface of the clamp and a protrusion is formed on the pivot arm wherein the protrusion is fitted into the through hole.

7. The sun visor for a vehicle according to claim 1, wherein the clamp is formed by a combination of a plurality of separate parts that are to be coupled.

8. The sun visor for a vehicle according to claim 1, wherein the support bar is a rectangular pillar, wherein the length thereof is adjustable.

9. The sun visor for a vehicle according to claim 1, wherein one end of the connection member is coupled to a vehicle body and the other end thereof is coupled to the pivot arm.

10. The sun visor for a vehicle according to claim 1, wherein the connection member is shaped as “L” character.

11. The sun visor for a vehicle according to claim 1, wherein an opening surface is formed toward a vehicle's interior on the body portion, and an extended portion is provided on the body portion and formed by an outermost of the body portion extended toward the opening surface at a predetermined length along a border of the opening surface.

12. The sun visor for a vehicle according to claim 11, wherein a mirror is inserted into an inward side of the opening surface, wherein the mirror is prevented from becoming detached from the body portion by the extended portion.

13. The sun visor for a vehicle of claim 12, wherein a door for opening or closing the mirror is provided on the opening surface to be guided by the extended portion when the door is slid.

14. The sun visor of claim 1, wherein a ticket holder is formed on one side of the body portion.
